(19) United States
(12) Patent Application Publication
(10) Pub. No.: US 2010/0277392 A1
(43) Pub. Date: Nov. 4, 2010

(54) CAPACITOR

(76) Inventors: Yen-Wei HSu, Taipei (TW); Whei-Chyou Wu, Fremont, CA (US)

Correspondence Address: Yen-Wei Hsu, 7F No. 58, Jhouzih St.,Neihu District,, Taipei, omitted

(21) Appl. No.: 12/432,761

(22) Filed: Apr. 30, 2009

(51) Int. Cl. H01Q 1/50; H01G 2/14

(52) U.S. Cl. 343/850; 361/272

(57) ABSTRACT

This invention relates to a capacitor, especially an energy discharge capacitor, which can also be used to improve the quality factor of antenna circuit and solve eddy current problem induced on a conductor.

### FIELD OF INVENTION

This invention relates to a capacitor, especially an energy discharge capacitor, which can also be used to improve the quality factor of antenna circuit and solve eddy current problem induced on a conductor.

### BACKGROUND INFORMATION

### Introduction

Referring to [5], [34], [41, Vol. 1 Chpater 50] and [24, Page 402], the nonlinear system response produces many un-modeled effects: jump or singularity, bifurcation, rectification, harmonic and subharmonic generations, frequency-amplitude relationship, phase-amplitude relationship, frequency entrainment, nonlinear oscillation, stability, modulations(amplitude, frequency, phase) and chaoes. In the nonlinear analysis fields, it needs to develop the mathematical tools for obtaining the resolution of nonlinearity. Up to now, there exists three fundamental problems which are self-adjoint operator, spectral(harmonic) analysis, and scattering problems, referred to [32, Chapter 4.], [38, Page 303], [35, Chapter X], [37, Chapter XI], [36, Chapter XIII], [25] and [34, Chapter 7.].

There are many articles involved the topics of the nonlinear spectral analysis and reviewed as the following sections. The first one is the nonlinear dynamics and self-excited or self-oscillation systems. It provides a profound viewpoint of the non-linear dynamical system behaviors, which are duality of second-order systems, self-excitation, orbital equivalence or structural stability, bifurcation, perturbation, harmonic balance, transient behaviors, frequency-amplitude and phase-amplitude relationships, jump phenomenon or singularity occurrence, frequency entrainment or synchronization, and so on. In particular, the self-induced current (voltage) or electricity generation appears if applying to the Liénard system.

TABLE 1
Mechanical v.s. Electrical Systems

| Mechanical Systems | | Electrical Systems | |
|---|---|---|---|
| m | mass | L | inductance |
| y | displacement | q | charge |
| $\frac{dy}{dt} = υ$ | velocity | $\frac{dq}{dt} = i$ | current |
| c | damping | R | resistance |
| k | spring constant | $\frac{1}{C}$ | reciprocal of capacitance |
| f (t) | input or driving force | E (t) | input or electromotive force |

### Comparision Between Electrical and Mechanical Systems

Referred to [3, Page 341], the comparison between mechanical and electrical systems as the table (1):

the damping coefficient c in a mechanical system is analogous to R in an electrical system such that the resistance R, in common, could be as a energy dissipative device. There exists a series problem caused by the analogy between the mechanical and electrical systems. As a result, the damping term has to be a specific bandwidth of frequency response and just behaved an absorbent property as the previous definitions. The resistance has neither to be the frequency response nor absorbing but just had the balance or circle feature only. This is a crucial misunderstanding for two analogous systems.

### Dielectric Materials

Referring to [31, Chapter 4, 5, 8, 9], [20, Part One], [21, Chapter 1], [8, Chapter 14], the response of a material to an electric field can be used to advantage even when no charge is transferred. These effects are described by the dielectric properties of the material. Dielectric materials poss a large energy gap between the valence and conduction bands, thus the materials a high electrical resistivity. Because dielectric materials are used in the AC circuits, the dipoles must be able to switch directions, often in the high frequencies, where the dipoles are atoms or groups of atoms that have an unbalanced charge. Alignment of dipoles causes polarization which determines the behavior of the dielectric material. Electronic and ionic polarization occur easily even at the high frequencies. Some energy is lost as heat when a dielectric material polarized in the AC electric field. The fraction of the energy lost during each reversal is the dielectric loss. The energy losses are due to current leakage and dipoles friction (or change the direction). Losses due to the current leakage are low if the electrical resistivity is high, typically which behaves 10¹¹ Ohm·m or more. Dipole friction occurs when reorientation of the dipoles is difficult, as in complex organic molecules. The greatest loss occurs at frequencies where the dipoles almost, but not quite, can be reoriented. At lower frequencies, losses are low because the dipoles have time to move. At higher frequencies, losses are low because the dipoles do not move at all.

For a capacitor made from dielectric ceramics, referred to [20, Part One], [21, Chapter 1], [31, Page 253-255], its capacitance C, which is equivalent to one ideal capacitor Cᵢ and series resistance Rₛ in the FIG. 5, is function of frequency ω, equivalent series resistance Rₛ and loss tangent of dielectric materials tan (δ) as

$$C = \frac{tan ( δ )}{{R}_{s} ω} \qquad ( 1 )$$

respectively. That is, if changing the Rₛ, an (δ) for different materials or ω, the C becomes a variable capacitance.

### Cauchy-Riemann Theorem

Referring to the [42], [12], [40] and [4], the complex variable analysis is a fundamental mathematical tool for the electrical circuit theory. In general, the impedance function consists of the real and imaginary parts. For each part of impedance functions, they are satisfied the Cauchy-Riemann Theorem. Let a complex function be

z(x,y)=F(x,y)+iG(x,y) (2)

where F(x,y) and G(x,y) are analytic functions in a domain D and the Cauchy-Riemann theorem is the first-order derivative of functions F(x,y) and G(x,y) with respect to x and y becomes

$$\begin{matrix}\frac{\partial F}{\partial x} = \frac{\partial G}{\partial y} \\ and & ( 3 ) \\ \frac{\partial F}{\partial y} = - \frac{\partial G}{\partial x} & ( 4 )\end{matrix}$$

Furthermore, taking the second-order derivative with respect to x and y,

$$\begin{matrix}\frac{{\partial }^{2} F}{\partial {x}^{2}} + \frac{{\partial }^{2} F}{\partial {y}^{2}} = 0 \\ and & ( 5 ) \\ \frac{{\partial }^{2} G}{\partial {x}^{2}} + \frac{{\partial }^{2} G}{\partial {y}^{2}} = 0 & ( 6 )\end{matrix}$$

also F(x,y) and G(x,y) are called the harmonic functions.

From the equation (2), the total derivative of the complex function z(x,y) is

$$d z ( x , y ) = ( \frac{\partial F}{\partial x} d x + \frac{\partial F}{\partial y} d y ) + i ( \frac{\partial G}{\partial x} d x + \frac{\partial G}{\partial y} d y ) \qquad ( 7 )$$

and substituting equations (3) and (4) into the form of (7), then the total derivative of the complex function (2) is dependent on the real function F(x,y) or in terms of the real-valued function F(x,y) (real part) only,

$$d z ( x , y ) = ( \frac{\partial F}{\partial x} d x + \frac{\partial F}{\partial y} d y ) + i ( \frac{\partial F}{\partial x} d y - \frac{\partial F}{\partial y} d x ) \qquad ( 8 )$$

and in terms of a real-valued function G(x,y) (imaginary part) only,

$$d z ( x , y ) = ( \frac{\partial G}{\partial y} d x - \frac{\partial G}{\partial x} d y ) + i ( \frac{\partial G}{\partial x} d x + \frac{\partial G}{\partial y} d y ) \qquad ( 9 )$$

There are the more crucial facts behind the (8) and (9) potentially. As a result, the total derivative of the complex function (7) depends on the real (imaginary) part of (2) function F(x,y) or G(x,y) only and never be a constant value function. One said, if changing the function of real part, the imaginary part function is also varied and determined by the real part via the equations (3) and (4). Since the functions F(x,y) and G(x,y) have to satisfy the equations (5) and (6), they are harmonic functions and then produce the frequency related elements discussed at the analytic continuation section. Moreover, the functions of real and imaginary parts are not entirely indepedent referred to the Hilbert transforms in the textbooks [18, Page 296] and [20, Page 5 and Appendix One].

### Analytic Continuation

The impedance of the circuit has been discussed in this section. According to the equation (11) has shown that a PDR and NDR coupled in series in a circuit can induce significant, enlarged harmonic, sub-harmonic, super-harmonic and intermediate harmonic components which will modulate all together to present multi-band waveforms with broad bandwidth.

For each analytic function F(z) in the domain D, the Laurent series expansion of F(z) is defined as the following

$$\begin{matrix}F ( z ) = {\sum }_{m = - ∞}^{∞} {{a}_{n} ( z - {z}_{0} )}^{n} \\ = … + {{a}_{- 2} ( z - {z}_{0} )}^{- 2} + {{a}_{- 1} ( z - {z}_{0} )}^{- 1} + {a}_{0} + …\end{matrix} \qquad ( 10 )$$

where the expansion center z₀ is arbitrarily selected. Since this domain D for this analytic finction F(z), any regular point imparts a center of a Laurent series [42, Page 223], i.e.,

$$F ( z ) = {\sum }_{- ∞}^{∞} {{c}_{n} ( z - {z}_{j} )}^{n}$$

where zⱼ is an arbitrary regular point in this complex analytic domain D for j=0, 1, 2, 3, . . . . For each index j, the complex variable is the product of its norm and phase,

$$z - {z}_{j} = \vert z - {z}_{j} \vert {e}^{{iθ}_{j}} \\ and \\ F ( z ) = {\sum }_{- ∞}^{∞} {c}_{n} {\vert z - {z}_{j} \vert}^{n} {e}^{i n {ω}_{j} t} \qquad ( 11 )$$

As long as a loop is formed the impedance function can be written in the form as the equation above. For each phase angle θⱼ, the corresponding frequency elements are naturally produced, say harmonic frequency ωⱼ. For different zⱼ correspond to the impedances with different values, frequencies and phases. Now we have the following results:
1. As the current passing through any smoothing conductor (without singularities), the frequencies are induced in nature.
2. This conductor imparts an order-∞ resonant coupler.
3. This conductor is to be as an antenna without any band-width limitation.
4. Dynamic impedance matched.

### Positive and Negative Differential Resistances (PDR, NDR)

More inventively, due to observing the positive and negative differential resistors properties qualitatively, we introduce the Cauchy-Riemann equations, [27, Part 1,2], [42], [12], [40] and [4], for describing a system impedance transient behaviors and particularly in some sophisticated characteristics system parametrization by one dedicated parameter ω. Consider the impedance z in specific variables (i,v) complex form of

z=F(i,v)+jG(i,v) (12)

where i, v are current and voltage respectively. Assumed that the functions F(i,v) and G(i,v) are analytic in the specific domain. From the Cauchy-Riemann equations (3) and (4) becomes as following

$$\begin{matrix}\frac{\partial F}{\partial i} = \frac{\partial G}{\partial v} \\ and & ( 13 ) \\ \frac{\partial F}{\partial v} = - \frac{\partial G}{\partial i} & ( 14 )\end{matrix}$$

where in these two functions there exists one relationship based on the Hilbert transforms [18, Page 296] and [20, Page 5]. In other words, the functions F(i,v) and G(i,v) do not be obtained individually. Using the chain rule, equations (13) and (14) are further obtained

$$\begin{matrix}\frac{\partial F}{\partial ω} \frac{d ω}{d i} = \frac{\partial G}{\partial ω} \frac{d ω}{d v} \\ and & ( 15 ) \\ \frac{\partial F}{\partial ω} \frac{d ω}{d v} = - \frac{\partial G}{\partial ω} \frac{d ω}{d i} & ( 16 )\end{matrix}$$

where the parameter ω could be the temperature field T, magnetic field flux intensity B, optical field intensity I, in the electric field for examples, voltage v, current i, frequency f or electrical power P, in the mechanical field for instance, magnitude of force F, and so on. Let the terms

$$\begin{matrix}\{ \begin{matrix}\frac{d ω}{d v} > 0 \\ \frac{d ω}{d i} > 0\end{matrix} \\ or & ( 17 ) \\ \{ \begin{matrix}\frac{d ω}{d v} < 0 \\ \frac{d ω}{d i} < 0\end{matrix} & ( 18 )\end{matrix}$$

be non-zero and the same sign. Under the same sign conditions as equation (17) or (18), from equation (15) to equation (16),

$$\begin{matrix}\frac{\partial F}{\partial ω} > 0 & ( 19 ) \\ \frac{\partial F}{\partial ω} < 0 \\ and & ( 20 ) \\ \frac{\partial F}{\partial ω} = 0 & ( 21 )\end{matrix}$$

should be held simultaneously, where (21) means a constant resistor. From the viewpoint of making a power source, the simple way to perform equations (17) and (18) is to use the pulse-width modulation (PWM) method. The further meaning of equations (17) and (18) is that using the variable frequency ω in pulse-width modulation to current and voltage is the most straight-forward way, i.e.,

$$\{ \begin{matrix}\frac{d ω}{d v} \neq 0 \\ \frac{d ω}{d i} \neq 0\end{matrix}$$

After obtaining the qualitative behavoirs of equation (19) and equation (20), also we need to further respectively define the quantative behavoirs of equation (19) and equation (20). Intuitively, any complete system described by the equation (12) could be analogy to the simple-parallel oscillator as FIG. 1 or simple-series oscillator as FIG. 2 which corresponds to 2^{nd}-order differential equation respectively either as (24) or (29). Referring to [41, Vol 2, Chapter 8,9,10,11,22,23], [17, Page 173], [6, Page 181], [22, Chapter 10] and [14, Page 951-968], as the FIG. 1, let the current iₗ and voltage v_{C} be replaced by x, y respectively. From the Kirchhoff's Law, this simple oscillator is expressed as the form of

$$\begin{matrix}L \frac{d x}{d t} = y & ( 22 ) \\ C \frac{d y}{d t} = - x + {F}_{p} ( y ) & ( 23 )\end{matrix}$$

or in matrix form

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}0 \\ \frac{{F}_{p} ( y )}{C}\end{matrix} ] \qquad ( 24 )$$

where the function Fₚ(y) represents the generalized Ohm's law and for the single variable case, Fₚ(x) is the real part functin of the impedance function equation (12), the “p” in short, is a “parallel” oscillator. Furthermore, equation (24) is a Liénard system. The quality factor Qₚ is defined as

$$\begin{matrix}{Q}_{p} ≡ \frac{1}{2 {ξ}_{p}} \\ = \frac{{ω}_{pn} {f}_{p} ( y )}{L}\end{matrix} \qquad ( 25 )$$

where ξₚ is the damping ration of (24),

$${ω}_{pn} = \frac{1}{\sqrt{L C}} \qquad ( 26 )$$

is the natural frequency of (24) and

$${f}_{p} ( y ) ≡ \frac{d {F}_{p} ( y )}{d y} {\vert}_{y}$$

respectively. If taking the linear from of Fₚ(y),

Fₚ(y)=Ky

and K>0, it is a normally linear Ohm's law. Also, the states equation of a simple series oscillator in the FIG. 2 is

$$\begin{matrix}L \frac{d x}{d t} = y - {F}_{s} ( x ) & ( 27 ) \\ C \frac{d y}{d t} = - x & ( 28 )\end{matrix}$$

in the matrix form,

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}- \frac{{F}_{s} ( x )}{L} \\ 0\end{matrix} ] \qquad ( 29 )$$

The i_{C}, vₗ have to be replaced by x, y respectively. The function Fₛ(x) indicates the generalized Ohm's law and (29) is the Liénard system too. The corresponding Qₛ value is

$$\begin{matrix}{Q}_{s} = \frac{{ω}_{sn} L}{{f}_{s} ( x )} \\ where & ( 30 ) \\ {ω}_{sn} = \frac{1}{\sqrt{L C}} & ( 31 )\end{matrix}$$

is the natural frequency of (29) and

$${f}_{s} ( x ) ≡ \frac{d {F}_{s} ( x )}{d x} {\vert}_{x}$$

respectively. Again, considering one system as the FIG. 2, let L,C be to one, then the system (29) becomes the form of

$$[ \begin{matrix}\frac{d x}{d t} \\ \frac{d y}{d t}\end{matrix} ] = [ \begin{matrix}y - {F}_{s} ( x ) \\ - x\end{matrix} ] \qquad ( 32 )$$

To obtain the equilibrium point of the system (29), setting the right hand side of the system (32) is zero

$$\{ \begin{matrix}y - {F}_{s} ( 0 ) = 0 \\ - x = 0\end{matrix}$$

where Fₛ(0) is a value of the generalized Ohm's law at zero. The gradient of (32) is

$$[ \begin{matrix}- {F}_{s}^{′} ( 0 ) & 1 \\ - 1 & 0\end{matrix} ]$$

Let the slope of the generalized Ohm's law F′ₛ(0) be a new function as ƒₛ(0)

ƒₛ(0)=F′ₛ(0)

the correspondent eigenvalues λ_{1,2}^{s} are as

$${λ}_{1 , 2}^{s} = \frac{1}{2} [ - {f}_{s} ( 0 ) \pm \sqrt{{( {f}_{s} ( 0 ) )}^{2} - 4} ]$$

Similarly, in the simple parallel oscillator (24),

ƒₚ(0)=F′ₚ(0)

the equilibrium point of (24) is set to (Fₚ(0), 0) and the gradient of (24) is

$$[ \begin{matrix}0 & 1 \\ - 1 & {f}_{p} ( 0 )\end{matrix} ]$$

the correspondent eigenvalues λ_{1,2}^{p} are

$${λ}_{1 , 2}^{p} = \frac{1}{2} ( {f}_{p} \pm \sqrt{{( {f}_{p} ( 0 ) )}^{2} - 4} )$$

The qualitative properties of the systems (24) and (29), referred to [14] and [22], are as the following:
1. ƒₛ(0)>0, or ƒₚ(0)<0, its correspondent equilibrium point is a sink.
2. ƒₛ(0)<0, or ƒₚ(0)>0, its correspondent equilibrium point is a source.
Thus, observing previous sink and source quite different defintions, if the slope value of impedance function Fₛ(x) or Fₚ(y), ƒₛ(x) or ƒₚ(y) is a positive value

F′ₛ(x)=ƒₛ(x)>0 (33)

or

F′ₚ(y)=ƒₚ(y)>0 (34)
it is the name of the positive differential resistivity or PDR. On contrary, it is a negative differential resistivity or NDR.

F′ₛ(x)=ƒₛ(x)<0 (35)

or

F′ₚ(y)=ƒₚ(y)<0 (36)
3. if ƒₛ(0)=0 or ƒₚ(0)=0 its correspondent equilibrium point is a bifurcation point, referred to [23, Page 433], [24, Page 26] and [22, Chapter 10] or fixed point [2, Chapter 1, 3, 5, 6], or singularity point, [7], [1, Chapter 22, 23, 24].

F′ₛ(x)=ƒₛ(x)=0 (37)

or

F′ₚ(y)=ƒₚ(y)=0 (38)

Liénard Stabilized Systems

This section has used periodical motion to check a system's stability, and also has explained the role of PDR and NDR in a stable system.

Taking the system equation (24) or equation (29) is treated as a nonlinear dynamical system analysis, we can extend these systems to be a classical result on the uniqueness of the limit cycle, referred to [1, Chapter 22, 23, 24], [24, Page 402-407], [33, Page 253-260], [22, Chapter 10,11] and many articles [26], [19], [30], [28], [29], [16], [11], [39], [10], [15], [9], [13] for a dynamical system as the form of

$$\{ \begin{matrix}\frac{d x}{d t} = y - F ( x ) \\ \frac{d y}{d t} = - g ( x )\end{matrix} \qquad ( 39 )$$

under certain conditions on the functions F and g or its equivalent form of a nonlinear dynamics

$$\frac{{d}^{2} x}{d {t}^{2}} + f ( x ) \frac{d x}{d t} + g ( x ) = 0 \qquad ( 40 )$$

where the damping function f(x) is the first derivative of impedance function F(x) with respect to the state x

ƒ(x)=F′(x) (41)

Based on the spectral decomposition theorem [23, Chapter 7], the damping function has to be a non-zero value if it is a stable system. The impedance function is a somehow specific pattern like as the FIG. 3,

y=F(x) (42)

From equation (39), equation (40) and equation (41), the impedance function F(x) is the integral of damping function ƒ(x) over one specific operated domanin x>0 as

$$F ( x ) = {\int }_{0}^{x} f ( s ) d s \qquad ( 43 )$$

Under the assumptions that F, g ε C¹ (R), F and g are odd functions of x, F(0)=0, F′(0)<0, F has single positive zero at x=a, and F increases monotonically to infinity for x≧a as x→∞ it follows that the Liénard's system equation (39) has exactly one limit cycle and it is stable. Comparing the (43) to the bifurcation point defined in the section ( ), the initial condition of the (43) is extended to an arbitrary setting as

$$F ( x ) = {\int }_{a}^{x} f ( ζ ) d ζ \qquad ( 44 )$$

where a ε R. Also, the FIG. 4 is modified as where the dashed lines are different initial conditions. Based on above proof and carefully observing the function (41) in the FIG. 4, we conclude the critical insights of the system (39). We conclude that an adaptive-dynamic damping function F(x) with the following properties:
1. The damping function is not a constant. At the interval,

α≦a
the impedance function F(x) is

F(x)<0
The function derivative of F(x) should be

F′(x)=ƒ(x)≧0 (45)
which is a PDR as defined by (33) or (34) and

F′(x)=ƒ(x)<0 (46)
which is a NDR as defined by (35) or (36), and both hold simultaneously. Which means that the impedance function F(x) has the negative and positive slopes at the interval α≦a.
2. Following the Liénard theorem [33, Page 253-260], [22, Chapter 10,11], [24, Chapter 8] and the correspondent theorems, corollaries and lemma, we can further conclude that one stabilized system which has at least one limit cycle, all solutions of the system (39) converge to this limit cycle even asymptotically stable periodic closed orbit. In fact, this kind of system construction can be realized a stabilized system in Poincaré sense [33, Page 253-260], [22, Chapter 10,11], [17, Chapter 1,2,3,4], [6, Chapter 3].

Furthermore, one nonlinear dynamic system is as the following form of

$$\begin{matrix}\frac{{d}^{2} x}{d {t}^{2}} + ɛ f ( x , y ) \frac{d x}{d t} + g ( x ) = 0 \\ or & ( 47 ) \\ \{ \begin{matrix}\frac{d t}{d t} = y - ɛ F ( x , y ) \\ \frac{d y}{d t} = - g ( x )\end{matrix} \\ where & ( 48 ) \\ f ( x , y ) & ( 49 )\end{matrix}$$

is a nonzero and nonlinear damping function,

g(x) (50)

is a nonlinear spring function, and

F(x,y) (51)

is a nonlinear impedance function also they are differentiable. If the following conditions are valid
1. there exists a>0 such that ƒ(x,y)>0 when \sqrt{x²+y²}≦a.
2. ƒ(0,0)<0 (hence ƒ(x,y)<0 in a neighborhood of the origin).
3. g(0)=0, g(x)>0 when x>0, and g(x)<0 when x<0.

$$4. G ( x ) = {\int }_{0}^{x} g ( u ) d u \to ∞ as x \to ∞ .$$

then (47) or (48) has at least one periodic solution.

### 0.1 Frequency-Shift Damping Effect

This section has used frequency shifting to re-define power generation and dissipation. This section also has revealed frequency shifting produced by a PDR and NDR coupled in series.

Referring to the books [4, p 313], [35, Page 10-11], [25, Page 13] and [40, page 171-174], we assume that the function is a trigonometric Fouries series generated by a function g(t) ε L(I), where g(t) should be bounded and the unbounded case in the book [40, page 171-174] has proved, and L(I) denotes Lebesgue-integrable on the interval I, then for each real β, we have

$${lim}_{ω \to ∞} {\int }_{I} g ( t ) {e}^{i ( ω t + β )} d t = 0 \qquad ( 52 )$$

where

e^{i(ωt+β)}=cos(ωt+β)+i sin(ωt+β)

the imaginary part of (52)

$${lim}_{ω \to ∞} {\int }_{I} g ( t ) sin ( ω t + β ) d t = 0 \qquad ( 53 )$$

and real part of (52)

$${lim}_{ω \to ∞} {\int }_{I} g ( t ) cos ( ω t + β ) d t = 0 \qquad ( 54 )$$

are approached to zero as taking the limit operation to infinity, ω→∞, where equation (53) or (54) is called “Riemann-Lebesgue lemma” and the parameter ω is a positive real number. If g(t) is a bounded constant and ω>0, it is naturally the (53) can be further derived into

$$\vert {\int }_{a}^{b} {e}^{i ( ω t + β )} d t \vert = \vert \frac{{e}^{i a ω} - {e}^{i b ω}}{ω} \vert \leq \frac{2}{ω}$$

where [a,b] ε I is the boundary condition and the result also holds if on the open interval (a,b). For an arbitrary positive real number ε>0, there exists a unit step function s(t), referred to [4, p 264], such that

$${\int }_{I}^{ } \vert g ( t ) - s ( t ) \vert d t < \frac{ɛ}{2}$$

Now there is a positive real number M such that if ω≧M,

$$\vert {\int }_{I}^{ } s ( t ) {e}^{i ( ω t + β )} \vert d t < \frac{ɛ}{2} \qquad ( 55 )$$

holds. Therefore, we have

$$\vert {\int }_{I}^{ } g ( t ) {e}^{i ( ω t + β )} d t \vert \leq \vert {\int }_{I}^{ } ( g ( t ) - s ( t ) ) {e}^{i ( ω t + β )} d t \vert + \vert {\int }_{I}^{ } s ( t ) {e}^{i ( ω t + β )} d t \vert \leq {\int }_{I}^{ } \vert g ( t ) - s ( t ) \vert d t + \frac{ɛ}{2} < \frac{ɛ}{2} + \frac{ɛ}{2} = ɛ \qquad ( 56 )$$

i.e., (53) or (54) is verified and hold.

According to the Riemann-Lebesgue lemma, the equation (52) or (54) and (53), as the frequency ω approaches to ∞ which means

$$ω ≫ 0 \\ then \\ {lim}_{ω \to ∞} {\int }_{I}^{ } g ( t ) {e}^{i ( ω t + β )} d t = 0 \qquad ( 57 )$$

The equation (57) is a foundation of the energy dissipation. For removing any destructive energy component, (57) tells us the truth whatever the frequencies are produced by the harmonic and subharmonic waveforms and completely “damped” out by the ultra-high frequency modulation.

Observing (57), the function g(t) is an amplitude of power which is the amplitude-frequency dependent and seen the book [24, Chapter 3,4,5,6]. It means if the higher frequency ω produced, the more g(t) is attenuated. When moving the more higher frequency, the energy of (57) is the more rapidly diminished. We conclude that a large part of the power has been dissipated to the excited frequency ω fast drifting across the board of each reasonable resonant point, rather than transferred into the thermal energy (heat). After all applying the energy to a system periodically causes the ω to be drifted continuously from low to very high frequencies for the energy absorbing and dissipating. Again removing the energy, the frequency rapidly returns to the nominal state. It is a fast recovery feature. That is, this system can be performed and quickly returned to the initial states periodically.

As the previous described, realized that the behavior of the frequency getting high as increasing the amplitude of energy and vice versa, expressed as the form of

ω=ω(g(t)) (58)

The amplitude-frequency relationship as (58) which induces the adaptation of system. It means which magnitude of the energy produces the corresponding frequency excitation like as a complex damper function (49).

Consider one typical example, assumed that given the voltage

v(t)=V₀e^{j(ω}^{ᵥ}^{t+α}^{ᵥ}⁾ (59)

and current

i(t)=I₀e^{j(ω}^{ᵢ}^{t+α}^{ᵢ}⁾ (60)

the total applied power is defined as

$$\begin{matrix}P = {\int }_{0}^{T} i ( t ) v ( t ) d t & ( 61 ) \\ = \frac{{V}_{0} {I}_{0}}{( {ω}_{v} + {ω}_{i} )} ( {e}^{j ( {α}_{v} + {α}_{i} + \frac{π}{2} )} ( 1 - {e}^{j ( {ω}_{v} + {ω}_{i} ) T} ) ) & ( 62 )\end{matrix}$$

Let the frequency ω and phase angle β be as

ω=ωᵥ+ωᵢ

and

β=αᵢ+αᵥ

then equation (62) becomes into the complex form of

$$\begin{matrix}P = π ( ω , β , T ) + j Q ( ω , β , T ) & ( 63 ) \\ = \frac{{V}_{0} {I}_{0}}{ω} ( {e}^{j ( β + \frac{π}{2} )} ( 1 - {e}^{j ω T} ) ) & ( 64 )\end{matrix}$$

where real power π(ω,β,T) is

$$π ( ω , β , T ) = \frac{2 {V}_{0} {I}_{0} sin ( ω T ) cos ( 2 π - 2 β - ω T )}{ω} \qquad ( 65 )$$

and virtual power Q(ω,β,T) is

$$Q ( ω , β , T ) = \frac{2 {V}_{0} {I}_{0} sin ( ω T ) sin ( 2 π - 2 β - ω T )}{ω} \qquad ( 66 )$$

respectively. Observing (52), taking limit operation to (63), (62) or (64),

$${lim}_{ω \to ∞} \frac{{V}_{0} {I}_{0}}{ω} ( {e}^{j ( β + \frac{π}{2} )} ( 1 - {e}^{j ω T} ) ) = 0 \qquad ( 67 )$$

the electric power P is able to filter out completely no matter how they are real power (65) or virtual power (66) via performing frequency-shift or Doppler's shift operation, where ωᵥ,ωᵢ are frequencies of the voltage v(t) and current i(t), and αᵥ,αᵢ are correspondent phase angles and T is operating period respectively. Let the real power to be zero,

$$2 π - 2 β - ω T = \frac{π}{2}$$

which means that the frequency ω is shifted to

$${ω}_{Vir} = \frac{1}{T} ( \frac{3 π}{2} - 2 β )$$

The total power (63) is converted to the maximized virtual power

$$Max ( Q ( {ω}_{Vir} , β , T ) ) = \frac{2 {V}_{0} {I}_{0} sin ( {ω}_{Vir} T )}{{ω}_{Vir}} \\ = \frac{2 {V}_{0} {I}_{0} T cos ( 2 β )}{( \frac{3 π}{2} - 2 β )}$$

### Similarly,

2π−2β−ωT=0

or

$${ω}_{Re} = \frac{2}{T} ( π - β )$$

the total power (63) is totally converted to the maximized real power

$$Max ( π ( {ω}_{Re} , β , T ) ) = \frac{2 {V}_{0} {I}_{0} sin ( {ω}_{Re} T )}{{ω}_{Re}} \\ = \frac{{V}_{0} {I}_{0} T sin ( 2 β )}{( β - π )}$$

In fact, moving out the frequency element ω as the (67) is power conversion between real power (65) and virtual power (66).

### Maximized Power Transfer Theorem

Consider the voltage source Vₛ to be

Vₛ=V₀

and its correspondent impedance Zₛ

Zₛ=Rₛ+jQₛ

The impedance of the system load Z_{L} is

Z_{L}=R_{L}+jQ_{L}

The maximized power transmission occurrence if R_{L} and Q_{L} are varied, not to be the constants,

R_{L}=Rₛ (68)

where the resistor Rₛ is called equivalent series resistance or ESR and

Q_{L}=−Qₛ (69)

Comparing (68) to (69), the impedances of voltage source and the system load should be conjugated, i.e.,

Z_{L}=Z*ₛ

then the overall impedance becomes the sum of Zₛ+Z_{L}, or

Z=Zₛ+Z_{L}=Rₛ+R_{L}+j(Qₛ+Q_{L}) (70)

The power of impedance consumption is

$$P = {I}^{2} {R}_{L} \\ = {( \frac{[ ( {R}_{s} + {R}_{L} ) - j ( {Q}_{s} + {Q}_{L} ) ]}{{( {R}_{s} + {R}_{L} )}^{2} + {( {Q}_{s} + {Q}_{L} )}^{2}} )}^{2} {V}_{0}^{2} {R}_{L}$$

Let the imaginary part of P be setting to zero,

(Qₛ+Q_{L})=0 (71)

i.e.,

Qₛ=−Q_{L}

or resonance mode. In fact, it is an impedance matched motion. The power of the total impedance consumption becomes just real part only,

$$P = \frac{{V}_{0}^{2} {R}_{L}}{{( {R}_{s} + {R}_{L} )}^{2}}$$

From the basic algebra,

$$\frac{{R}_{s} + {R}_{L}}{2} \geq \sqrt{{R}_{s} {R}_{L}}$$

where Rₛ and R_{L} have to be the positive values,

Rₛ,R_{L}≧0 (72)

or

(Rₛ−R_{L})²=0

In other words, the resistance Rₛ and R_{L} are the same magnitudes as

Rₛ=R_{L} (73)

The power of impedance consumption P becomes an averaged power Pₐᵥ

$${P}_{av} = \frac{1}{2} \frac{{V}_{0}^{2}}{{R}_{L}} \\ = \frac{{V}_{0}^{2}}{( 2 {R}_{L} )} \qquad ( 74 )$$

and the total impedance becomes twice of the resistance R_{L} or Rₛ.

Z=2R_{L} (75)

Let (69) be a zero, i.e., impedance matched,

Qₛ=Q_{L}=0 (76)

from (73), the total impedance and consumed power P are (75), (74) respectively. In other word, comparing the (2) to (76), it is hard to implement that the imaginary part of impedance (70) keeps zero. But applying the (3) and (4) operations into the form of (7), the results have been verified on the Cauchy-Riemann theorem, also it is a possible way to create the zero value of imaginary part of total impedance (70) or (7). Another way is producing a conjugated part of (70) or (7) dynamically and adaptively or order-∞ resonance mode.

### REFERENCES

[1] Nicholas Minorsky. Nonlinear oscillations. Van Nostrand, New York., http://www.alibris.com, 1962.
[2] Alberto Abbondandolo. Morse Theory for Hamiltonian Systems. CRC Press., http://www.crcpress.com/, 2000.
[3] D. K. Anand. An Introduction to Control Systems. Pergamon Press., http://www.amazon.com/, 1974.
[4] Tom M. Apostol. Mathematical Analysis. Addison-Wesley Publishing Company., http://www.aw-bc.com/, 2nd edition, 1975.
[5] V. I. Arnold. Ordinary Differential Equations. MIT Press., http://www.mitpress.com/, 1973.
[6] V. I. Arnold. Geometrical Methods in the Theory of Ordinary Differential Equations. Springer-Verlag., http://www.springer-ny.com/, 2nd edition, 1988.
[7] V. I. Arnold. Theory of Singularities and its Applicatoins., volume 1. American Mathematicial Society., http://www.ams.org/, 2nd edition, 1990.
[8] Donald R. Askeland. The Science and Engineering of Materials. PWS Publishers., alternate edition, 1985.
[9] J. Balakrishnan. A geometric framework for phase synchronization in coupled noisy nonlinear systems. Physical Review E, 73:036206, 2006.
[10] Timoteo Carletti and Gabriele Villari. A note on existence and uniqueness of limit cycles for li'enard systems, 2003.
[11] V. K. Chandrasekar, M. Senthilvelan, and M. Lakshmanan. An unusual li'enard type nonlinear oscillator with properties of a linear harmonic oscillator, 2004.
[12] E. T. Copson. An introduction to the theory of functions of a complex variable. Oxford University Press., http://www.amazon.com/, 4th edition, 1948.
[13] M. C. Cross, A. Zumdieck, Ron Lifshitz, and J. L. Rogers. Synchronization by nonlinear frequency pulling. Physical Review Letters, 93:224101, 2004.
[14] R. Wong F. Cuker. The Collected Papers of Stephen Smale., volume 3. Singapore University Press., http://www.worldscibooks.com/mathematics, 2000.
[15] H. Giacomini and S. Neukirch. On the number of limit cycles of the lienard equation, 1997.
[16] Jaume Gine and Maite Grau. A note on “relaxation oscillators with exact limit cycles”, 2005.
[17] John Guckenheimer and Philip Holmes. Nonlinear Oscillations, Dynamical Systems, and Bifurcations of Vector Fields. Springer-Verlag., http://www.springer-ny.com/, 1997.
[18] Ernest A. Guillemin, editor. Synthesis of Passive Networks: Theory and Methods Appropriate to the Realization and Approximation Problems. John Wiley and Sons., 1957.
[19] Edward H. Hellen and Matthew J. Lanctot. Nonlinear damping of the lc circuit using anti-parallel diodes, 2006.
[20] Arthur R. Von Hippel. Dielectrics and Waves. A John Wiley and Sun, Inc., http://www.wiley.com, 1954.
[21] Arthur Von Hippel. Dielectric Materials and Applications. Artech House Publishers., http://www.artechhouse.com, 1995.
[22] Morris W. Hirsh and Stephen Smale. Differential Equations, Dynamical Systems and Linear Algebra. Academic Press., http://www.academicpress.com/, 1974.
[23] Thomas J. R. Hughes. Jerrold E. Marsden. Mathematical Foundations of Elasticity. Prentice-Hall, Inc., http://www.doverpublications.com/, 1984.
[24] D. W. Jordan and Peter Smith. Nonlinear Ordinary Differential Equations. Oxford University Press., http://www.oup.co.uk/academic/, 3rd edition, 1999.
[25] Yitzhak Katznelson. An Introduction to Harmonic Analysis. Cambridge University Press, http://www.amazon.com/, 2nd edition, 1968.
[26] Alexandra S. Landsman and Ira B. Schwartz. Predictions of ultra-harmonic oscillations in coupled arrays of limit cycle oscillators, 2006.
[27] Serge Lang. Complex Analysis. Springer-Verlag., http://www.springer.de/phy/books/ssp, 4th edition, 1999.
[28] Jose-Luis Lopez and Ricardo Lopez-Ruiz. The limit cycles of lienard equations in the strongly non-linear regime, 2002.
[29] Jose-Luis Lopez and Ricardo Lopez-Ruiz. Approximating the amplitude and form of limit cycles in the weakly non-linear regime of lienard systems, 2006.
[30] Jose-Luis Lopez and Ricardo Lopez-Ruiz. The limit cycles of lienard equations in the weakly nonlinear regime, 2006.
[31] A. J. Moulson and J. M. Herbert. Electroceramics: Materials, Properties, Applications. Wiley and Sun Ltd., http://www3.wileye.com, 2nd edition, 2003.
[32] Peter J. Olver. Applications of Lie Groups to Differential Equations. Springer-Verlag., http://www.springer-ny.com/, 1993.
[33] Lawrence Perko. Differential Equations and Dynamical Systems. Springer-Verlag, New York, Inc., http://www.springer-ny.com, 3rd edition, 2000.
[34] Jerrold E. Marsden. Ralph Abraham. Foundations of Mechanics. Perseus Publishing., http://www.perseusbooksgroup.com/front.html, 2nd edition, 1984.
[35] Michael Reed and Barry Simon. Methods of Modern Mathematical Physics: Fourier Analysis, Self-Adjointness., volume 2. Academic Press., http://www.academicpress.com, 1975.
[36] Michael Reed and Barry Simon. Methods of Modern Mathematical Physics: Analysis of Operators., volume 4. Academic Press., http://www.academicpress.com, 1978.
[37] Michael Reed and Barry Simon. Methods of Modern Mathematical Physics: Scattering Theory., volume 3. Academic Press., http://www.academicpress.com, 1979.
[38] George F. Simmons. Introduction to Topology and Modern Analysis. McGRAW-HILL Inc., http://books.mcgraw-hill.com, 1963.
[39] Ali Taghavi. On periodic solutions of lienard equations, 2004.
[40] E. T. Whittaker and G. N. Watson. A Course of Modern Analysis. Cambridge Mathematical Library., http://www.cambridge.org, 4th edition, 1927.
[41] Matthew Sands. W Richard P. Feynman, Robert B. Leighton. Feynman Lectures On Physics: The Complete And Definitive Issue., volume 3. Addison Wesley Publishing Company., http://www.aw-bc.com, 2nd edition, 1964.
[42] A. David Wunsch. Complex Variables with Applications. Addison-Wesley Publishing Company Inc., http://www.aw-bc.com/, 1983.

### SUMMARY OF THE INVENTION

It is a first objective of the present invention to provide an energy discharge capacitor which can dissipate the charged energy in the capacitor.

It is a second objective of the present invention to provide a method for the dissipation of electrical power by high frequency modulation, and the dissipation of electrical power can be controlled by fields interactions, and the energy discharge capacitor uses the method.

It is a third objective of the present invention to improve sensitivity or quality factor Q of an antenna circuit by implementing the energy discharge capacitor, a PDR device and a NDR device into the antenna circuit.

It is a fourth objective of the present invention to use the energy discharge capacitor to solve eddy current problem.

### BRIEF DESCRIPTION OF THE DRAWINGS

FIG. 1 has shown a parallel oscillator;

FIG. 2 has shown a serial oscillator;

FIG. 3 has shown the function F(x) and a trajectory Γ of Liénard system;

FIG. 4 has shown the impedance function F(x) is independent of the initial condition setting;

FIG. 5 a capacitor C decomposed into an ideal capacitor Cᵢ, a series parasitic resistor Rₛ;

FIG. 6 has shown that three NDR devices coupled in series with each other are compensated into the closed loop of FIG. 10b;

FIG. 7a has shown the structure of a typical capacitor using parallel plate model;

FIG. 7b is the conventional expression of a typical capacitor;

FIG. 7c has shown that the two conductive electrodes of the capacitor of FIG. 7a are respectively electrically connected with two terminals;

FIG. 7d has shown that the two conductive electrodes of the capacitor of FIG. 7b are respectively electrically connected with two terminals;

FIG. 8 has shown that the dielectric of an energy discharge capacitor is formed by three layers of which a ferromagnetic layer is sandwitched between the two ferroelectrical layers;

FIG. 9 has shown that the dielectric of an energy discharge capacitor is formed by four layers of which a ferromagnetic layer and a ferro-optical layer are disposed between the two ferroelectrical layers;

FIG. 10a has demonstrated an experiment of how the eddy currents are induced on and in a conductor;

FIG. 10b has shown a closed loop formed with the energy discharge capacitor and the conductor shown in FIG. 10a to solve the eddy currents;

FIG. 11 has shown that the eddy currents as well as magnetic flux are maximum at the material surface and they attenuate and lag in phase with increasing depth;

FIG. 12a has shown a serial antenna circuit which has been modeled by a resistor, a capacitor and an inductor coupled in series with each other;

FIG. 12b has shown a parallel antenna circuit which has been modeled by a resistor, a capacitor and an inductor coupled in parallel with each other;

FIG. 12c has shown that the antenna circuit of FIG. 12a has been modified by replacing the resistor with a PDR device and a NDR device coupled in series and replacing the capacitor with the energy discharge capacitor; and

FIG. 12d has shown that the antenna circuit of FIG. 12b has been modified by replacing the resistor with a PDR device and a NDR device coupled in series and replacing the capacitor with the energy discharge capacitor.

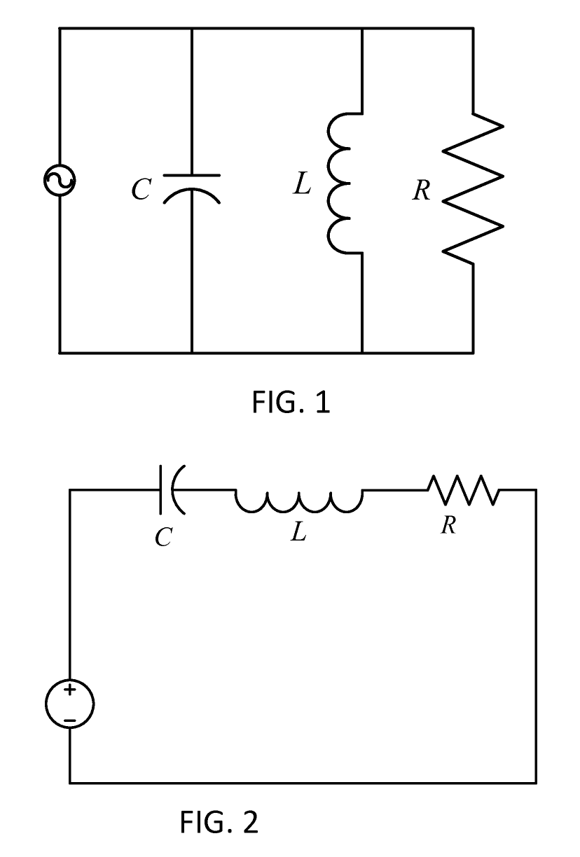

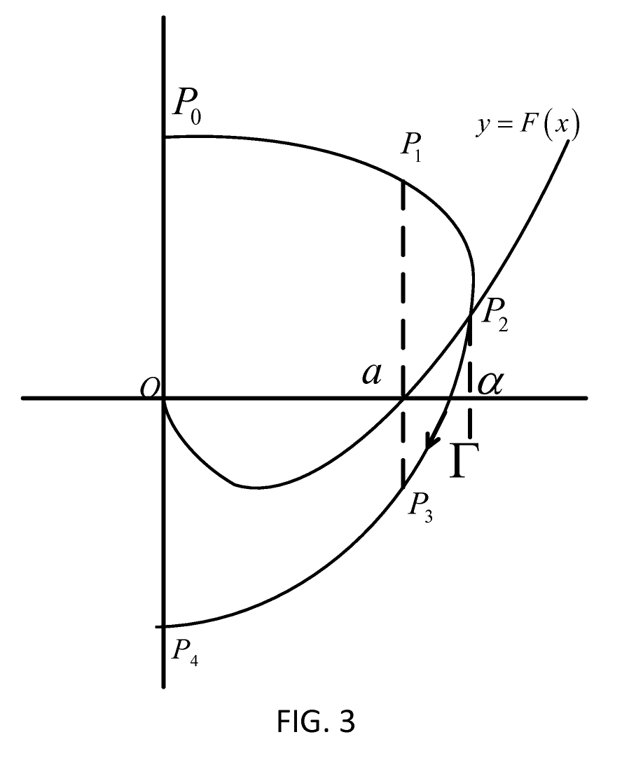

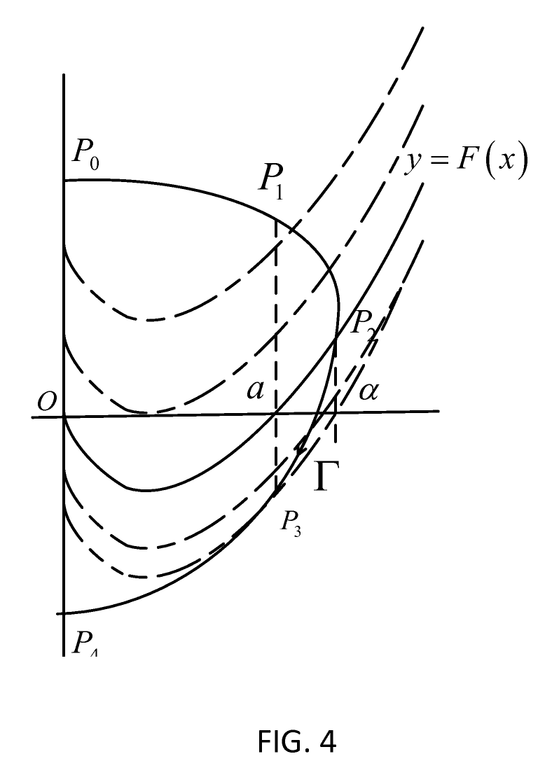

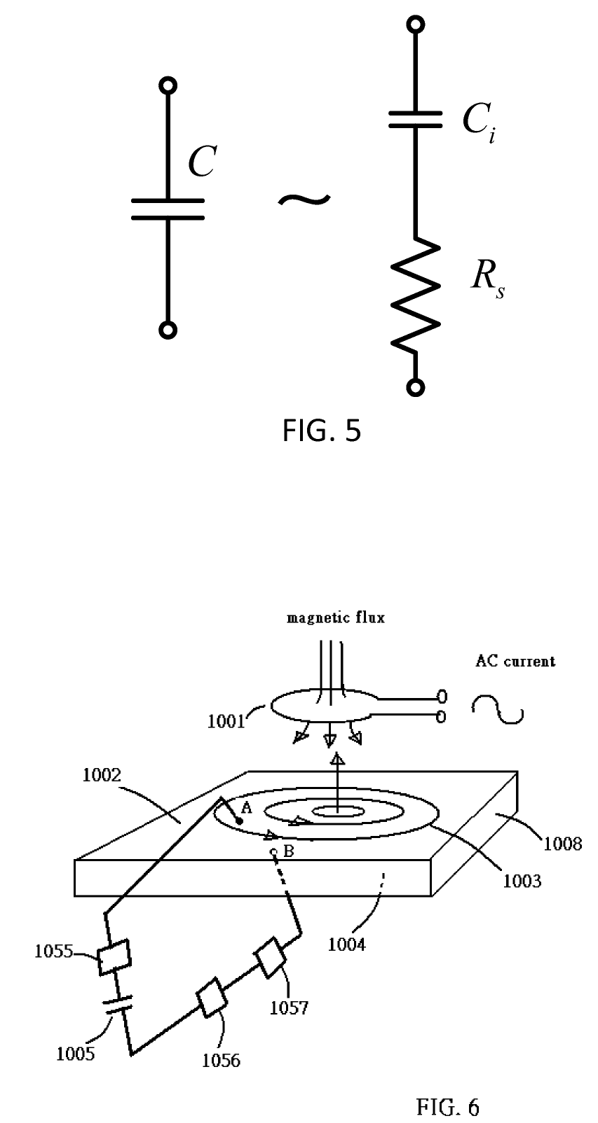

### DETAILED DESCRIPTION OF THE INVENTION

The impedance of the circuit has been analyzed in the analytic continuation of the background information section. For any close loop the impedance function can be written as the following equation in the complex form having real and imaginary parts as the equation (11) and the following three parts equations (17), (18) and (21) hold simultaneously. Equations (17), (18) and (21) are the natural or intrinsic properties in any closed loop. Equations (17) and (18) are respectively defined as positive differential resistance or PDR in short and negative differential resistance or NDR in short in the present invention, and, equation (21) stands for a pure resistance which is irrelevant to frequency. A device having PDR or NDR is called PDR device or NDR device in the present invention. A device having PDR and NDR is called PNDR device in the present invention. Revealed in the “Positive and Negative Differential Resistances” of the background information section, the PDR and NDR can be interactable with energy fields which could be temperature field T, magnetic field such as magnetic flux intensity B, optical field such as optical field intensity I, electric field such as voltage v, current i, frequency f, electrical power P, acoustic field, mechanical field such as magnitude of force F, or any combinations of them listed above.

For any closed loop, obviously, the two equations (17) and (18) can be respectively carried out by a PDR device and a NDR device and the two simultaneously held equations (17) and (18) can be respectively carried out by a PDR device and a NDR device coupled in series.

Any closed loop without frequency responding devices such as the PDR and NDR devices those intrinsic properties of (17) and (18) can not be realized, which means that the loop's dynamic behavior is much more suppressed, concealed and difficult to be observable. In other words, a loop's dynamic behavior will be much more significantly observable if the loop has frequency responding device such as the PDR and NDR devices. Any closed loop without frequency responding device the loop's static behavior will be much more stood out than its dynamical behavior and the loop will have no or insignificant frequency response.

The impedance function equation (11) expressed in spectrum domain is true for any closed loop and tells that the loop in nature includes unlimited harmonic, sub-harmonic, super-harmonic, intermediate harmonic components and the combinations of them in a multi-band waveforms with very broad bandwidth, but without frequency responding device in the loop some or all of the waveform components may be concealed, suppressed or in insignificantly observable mode. With frequency responding devices such as PDR and NDR devices in the loop can make the waveforms governed by the impedance function equation (11) significantly observable. A loop having at least a PDR device and a NDR device coupled in series can have significant, more observable and enlarged harmonic, sub-harmonic, super-harmonic and intermediate harmonic components which will modulate all together to generate more significantly observable multi-band waveforms with considerably broad bandwidth. The mathematical equation (57) has been proved true for any g(t) in 1902. The integral part of the equation can be the form or expression of electrical power if it is interpreted into electrical domain and tells that it includes amplitude, frequency and phase. By taking frequency limit operation on the equation its integral (or summation) is approaching to zero, which can be interpreted that the electrical power will be dissipated if frequency shifted to higher enough. It's noticed that the result after summation of the equation (57) is not function of time, which means that the dissipation of electrical power is not done by a given time internal instead the dissipation of electrical power is done by frequency shifting at an instant time. It means that the dissipation of electrical power can be done in a very effective and quick way. The “electrical power” used in here is defined as (61) in term of current and voltage (i.e. the convolution of current and voltage). The “dissipation of electrical power” means that the electrical power in term of current and voltage is transformed into another energy forms such as RF, magnetic field, optical field, heat, etc, or any combination of them. For example, frequencies in and out CPU respectively are around 20 kHz and 3 GHz so that a lot of the electrical power is transformed into heat under this high frequency modulation, which explains why CPU needs a strong fan and also proves that the design of current CPU is wrong in the view point of energy management. For another example, the PDR and NDR devices coupled in series in a closed loop can generate very large-scale frequency shifting so that the electrical power will be dissipated as revealed by the equation (57).

Revealed in the frequency-shift damping effect of the background information section, a PDR device and a NDR device coupled in series has frequency-shift damping effect which can perform higher-frequency shifting and dissipate electrical power in the process of the frequency-shifting. A loop having A PDR and a NDR devices can perform the dissipation of electrical power if their frequency responses are higher enough. And further, as earlier revelation, the PDR and NDR are field-interactable so that the dissipation of electrical power of a loop can be controlled by fields interactions listed above. This is a new method of the dissipation of electrical power of any closed loop by ultra-high frequency modulation revealed by the present invention.

The equation (1) is true for any capacitor of which dieletric has real and imaginary components, and according to the equation, for a specific dielectric material tan (δ), capacitance C of capacitor are dependent with resistance Rₛ and frequency ω. For constant resistance Rₛ, capacitance C is dependent on frequency ω. For varying resistance Rₛ, capacitance C is dependent on varying resistance Rₛ and varying frequency ω.

The capacitance C of capacitor with varying Rₛ will be broader than that with constant Rₛ. For violently varying Rₛ the capacitor will have large-scale varying capacitance C as expected. A broader and more violently varying capacitances of a capacitor are expected with more violently varying resistances of the capacitor. The PDR and NDR devices can be implemented into capacitor and contribute the role of varying resistances and frequency-shift damping effect which includes the dissipation of electrical power. A capacitor which comprises a PDR device and a NDR device can also be called “energy discharge capacitor” in the present invention. When current with a specific frequency flows through the energy discharge capacitor capacitor then the capacitor is quickly charged and then the charged energy will be dissipated in the process of very high frequency shifting.

The term “ferroelectricity” is used in analogy to ferromagnetism, in which a material exhibits a permanent magnetic moment. Ferromagnetism was already known when ferroelectricity was discovered in 1920. The ferroelectricity is a spontaneous electric polarization of a material that can be reversed by the application of an external electric field. Ferroelectric materials have advantages over other materials when used in capacitors, for example, ferroelectric materials have a higher charge storing capacity, and exhibits smaller resistance and higher switching frequencies between its two poles. The known ferroelectric capacitor is a capacitor based on a ferroelectric material. Same way, the term “ferro-optical” is used in the present invention in analogy to both the ferromagnetism and ferroelectricity. The ferro-optical is a spontaneous polarization of a material that can be reversed by the application of an external optical field. In analogy to the ferroelectric capacitor, the ferromagnetic or/and ferro-optical materials can also be implemented into capacitor, which makes the capacitor a magnetic or/and optical fields interactable capacitor.

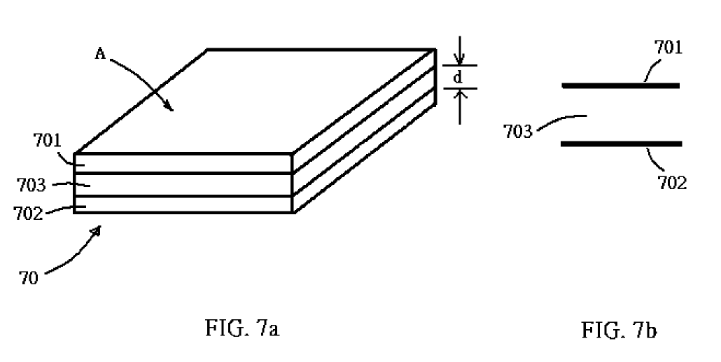

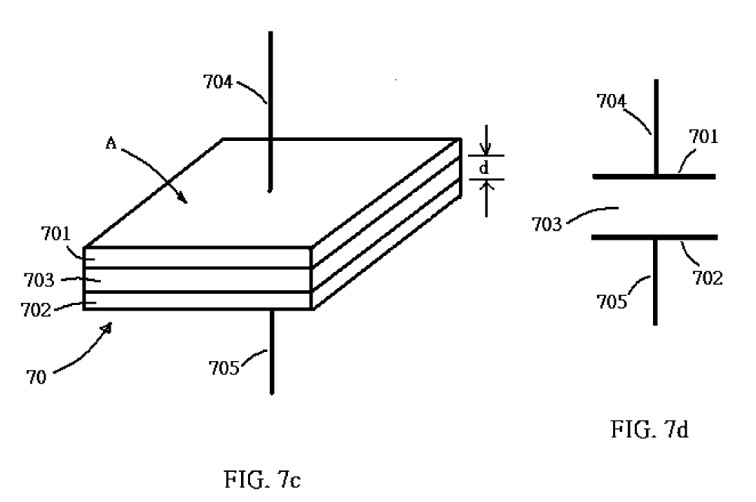

A typical capacitor consists of two conductive electrodes separated by a dielectric. A typical capacitor can be expressed in FIG. 7a by using parallel plate model or a typical capacitor can be simply expressed by FIG. 7b. A capacitor 70 consists of a first conductive electrode 701 and a second conductive electrode 702 separated by a dielectric 703. FIG. 7a has shown that the dielectric 703 is disposed between two conductive electrodes 701 and 702, each of area A and with a separation of d. The capacitor of FIG. 7a or 7b might need terminals respectively electrically connected with two conductive electrodes for electrically connecting with outside circuits. FIGS. 7c and 7d have shown that a first terminal 704 and a second terminal 705 are respectively electrically connected with the first conductive electrode 701 and the second conductive electrode 702 of the capacitor of FIG. 7a or 7b. It's again noticed that the dielectric of capacitor includes ferroelectric, ferromagnetic, ferro-optical material or any combinations of them which makes the capacitor of the present invention a field-interactable capacitor.

A capacitor which comprises a PDR device and a NDR device can be called “energy discharge capacitor” in the present invention. For the structure of the capacitor of FIG. 7a or 7b, an energy discharge capacitor can be obtained if the first conductive electrode 701 is a PDR device and the second conductive electrode is a NDR device. For the capacitor having terminals shown in FIG. 7c or 7d, an energy discharge capacitor can be obtained if at least two of the first terminal 704, the second terminals 705, the first conductive electrode 701 and the second conductive electrodes 702 are respectively a PDR device and a NDR device. For example, a capacitor can be an energy discharge capacitor if, the first and second conductive electrodes 701, 702 are respectively a PDR device and a NDR device, the first terminal 704 is a PDR device and the second conductive electrode 702 is a NDR device, the first terminal 704 and the first conductive electrode 701 are PDR devices and the second conductive electrode 702 is a NDR device, the first terminal 704 and the first conductive electrode 701 are NDR devices and the second conductive electrode 702 is a PDR device, the first terminal 704 and the first conductive electrode 701 are NDR devices and the second terminal 705 and the second conductive electrode 702 are PDR devices, the first terminal 704 and the first conductive electrode 701 are PDR devices and the second terminal 705 and the second conductive electrode 702 are NDR devices, or the first terminal 704 and the first conductive electrode 701 are NDR devices and the second terminal 705 and the second conductive electrode 702 are PDR devices, etc. The present invention is not limited to any particular dielectric of the energy discharge capacitor. For example, the dielectric of the present invention “energy discharge capacitor” includes ferroelectric material, ferromagnetic material, ferro-optical material or any combinations of them.

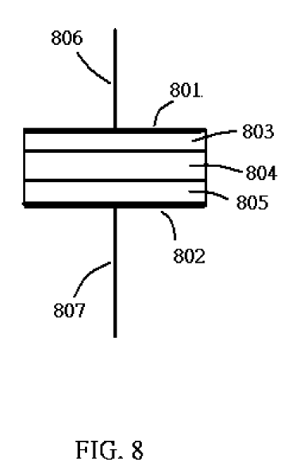

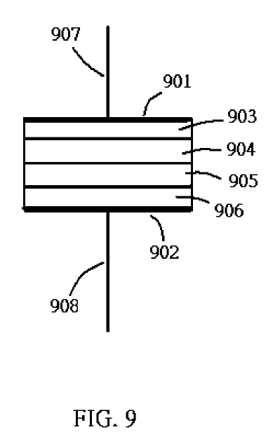

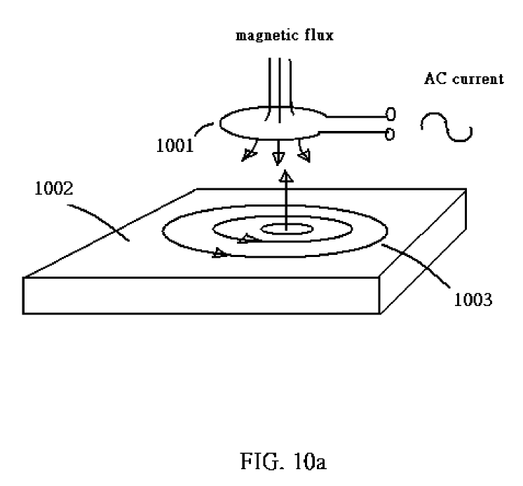

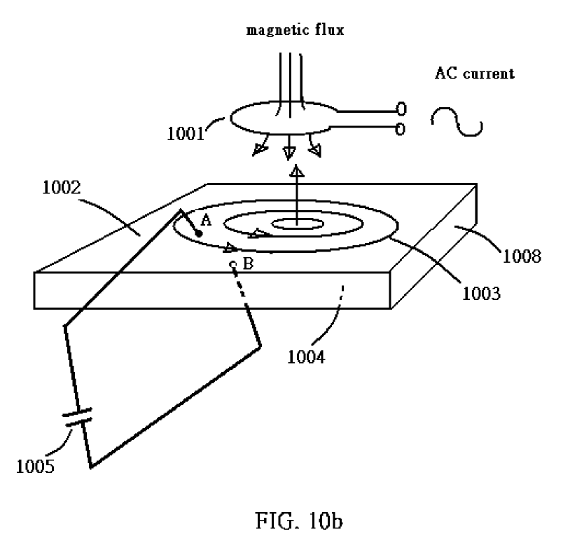

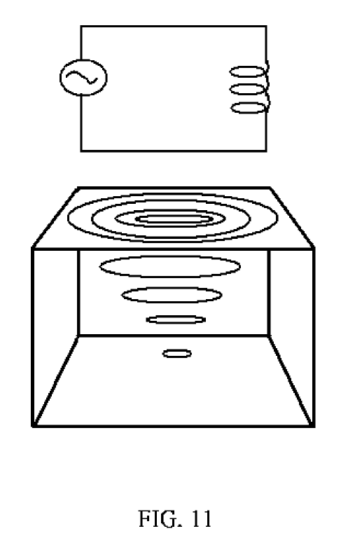

An embodiment of the energy discharge capacitor shown in FIG. 8 of which the dielectric is formed by three layers which includes two ferroelectric layers 803, 805 and a ferromagnetic layer 804 disposed between the two ferroelectric layers 803 and 805. The ferroelectric and ferromagnetic dielectrics of the capacitor of FIG. 8 make the capacitor interactable with both electrical and magnetic fields. The ferromagnetic layer 804 disposed between the two ferroelectric layers 803, 805 of FIG. 8 can be replaced by a ferro-optical material to make the capacitor interactable with both electrical and optical fields. FIG. 9 has shown another embodiment of the energy discharge capacitor of which the dielectric is formed by four layers of which a ferro-optical layer 905 and a ferromagnetic layer 904 are disposed between the two ferroelectric layers 903, 906. The two ferroelectric layers of both embodiments of the capacitors of FIG. 8 and FIG. 9 are respectively disposed adjacent to the two conductive electrodes for being more sensitively polarized to electric field entered from the two conductive electrodes. The dieletric of the energy discharge capacitor also contributes the varying resistances of the capacitor when interacted with field but the PDR and NDR devices of capacitor have more immediate responses to the electrical field from their physically contacted wires of the loop. One of the many applications of the energy discharge capacitor is for detecting and solving eddy current problem. The eddy current is caused when a moving (or changing) magnetic field intersects a conductor, or vice-versa. The relative motion causes a circulating flow of electrons, or current, within the conductor. Eddy current transforms useful forms of energy, such as kinectic energy, into heat. In many devices, this Joule heat reduces efficiency of iron-core transformers and electric motors and other devices that use changing magnetic fields. FIG. 10a has shown a simplied scheme in which an AC current is applied on a coil 1001 and closed loops of eddy currents 1003 are generated on a conductor plate 1002. FIG. 11 has shown that the eddy currents as well as magnetic flux are maximum at the material surface and they attenuate and lag in phase with increasing depth. The surface of a body where eddy currents are induced is called eddy-current surface and the surface of the body without eddy current is called no-eddy-current surface in the present invention.

Capacitor has characterization that current is leading voltage in phase such that capacitor is a good device for solving eddy current problems. By using FIG. 10a and shown in FIG. 10b, a closed loop is formed by electrically connecting the first and second terminals of the capacitor 1005 respectively with the eddy-current surface 1002 and no-eddy-current surface 1004 of the conductor plate 1008. The surface opposite to the eddy-current surface 1002 of the conductor plate 1008 is chosen as the no-eddy-current surface 1004 in the embodiment of FIG. 10b.

The eddy currents have characterization that they are AC and their amplitude, bandwidths and orientations are hard to be predicted. What we hope is that the induced AC eddy currents or electron charges can leave the eddy-current surface of the conductor plate flowing through the loop formed with the energy discharge capacitor to get them dissipated. A more effective way to let the eddy currents more like to leave the eddy-current surface and flow through the closed loop formed by the energy discharge capacitor is to generate potential differences or perturbations in the loop. One way to generate potential differences or perturbations in the loop can be done by coating a layer of a NDR device on the eddy-current surface 1002 or on both the eddy-current surface 1002 and no-eddy-current surface 1004 of the conductor plate. The term “coating a layer of a NDR device on the eddy-current surface” means that the NDR device is in the form of a layer and in physically contact with or physically cover on the eddy-current surface. As long as electrical charges (i.e. eddy currents) are induced on the NDR-coating surface of the conductor the resistance of the NDR layer starts to change and becomes smaller (current becomes larger), which becomes a perturbing or self-excitation potential difference source in the closed loop formed with the energy discharge capacitor. The produced perturbation in the loop can be a driving force for the AC eddy currents more like to leave the eddy-current surface and flow thru the loop formed with the energy discharge capacitor and then the charged energy in the energy discharge capacitor will be dissipated finally. Further, as earlier revealed, the PDR and NDR devices are interactable with fields as temperature field T, magnetic field such as magnetic flux intensity B, optical field such as optical field intensity I, electric field such as voltage v, current i, frequency f, electrical power P, acoustic field, mechanical field such as magnitude of force F, or any combinations of them. The resistances of the PDR and NDR devices in the loop formed with the energy discharge capacitor will change if they are applied by their interacted field(s). The application of the field or fields on the PDR and NDR devices can be through contacting and contactless ways, for example, the application of optical and magnetic fields can be through contactless method while the application of electrical field can be through contacting method. The PDR or PDRs and the NDR or NDRs in the loop formed with the energy discharge capacitor under the applications of their respectively interacted fields can be another perturbing sources. The PDR and NDR devices in the loop include the PDR and NDR devices of the energy discharge capacitor.

The varying extent of resistance of a NDR device usually is smaller than that of a PDR device and the PDR device can be found almost everywhere so that more NDR devices can be compensated to the loop, which explains why both the eddy-current and no-eddy-current surfaces are coated with a layer of NDR device. A loop having well-balanced PDR and NDR devices will prevent current from saturation in the loop. An embodiment by modifying FIG. 10b has been shown in FIG. 6. FIG. has shown that three NDR devices coupled in series are compensated to the closed loop of FIG. 10b formed with the energy discharge capacitor 1005. For example, if the first NDR device is interacted with thermal field, the second NDR device is interacted with optical field and the third NDR device is interacted with magnetic field. The resistances of the three NDR devices will change when the three NDR devices are respectively under the applications of their respectively interacted fields, which can be viewed as perturbing sources in the closed loop. Further, if the eddy-current surface 1002 of the conductor plate 1008 is coated with a layer of a NDR device, when electrical charges (i.e. eddy currents) are induced on the NDR-coating surface 1002 of the conductor 1008 the perturbing sources from the resistance variations contributed from of the NDR-coating surface 1002 and the applications of the energy fields will create more potential differences to flow currents in the loop. The eddy-current surface coated with the NDR device is important because the NDR device has immediate responses to the induced eddy currents and charges, and further, if the NDR device is under the application of its interactable field then its NDR property will be much more significant.

The differential property in resistances causes the induced charges flowing in the loop. The coated layer of the NDR device is also good for attracting the induced charges of eddy currents as surface as possible.

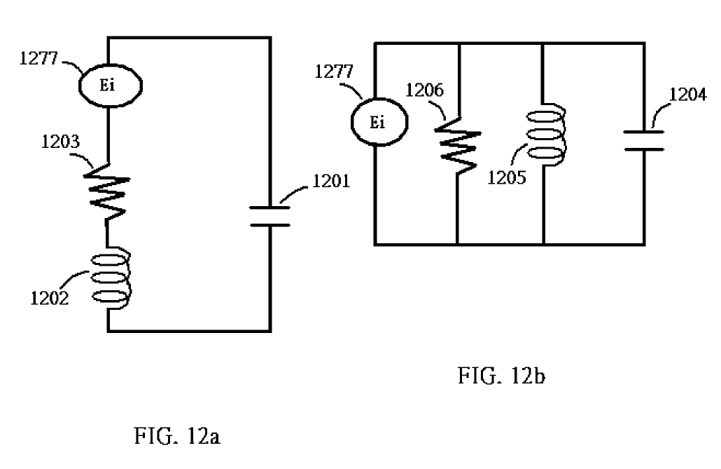

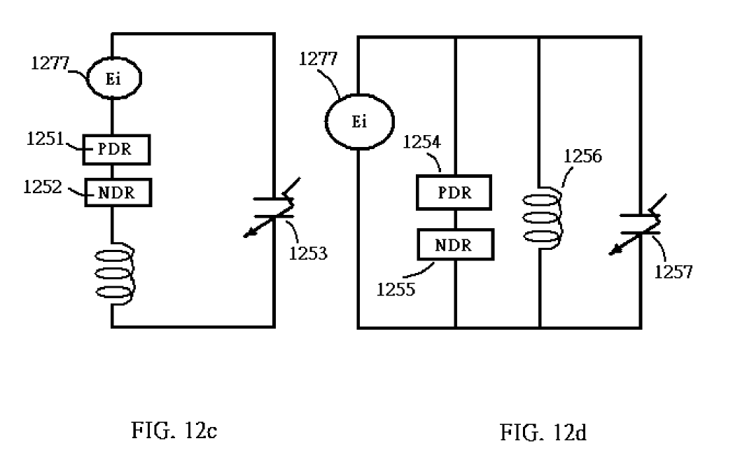

Another application for the energy discharge capacitor is for improving the sensivity or quality factor Q of an antenna circuit. It has been well known that an antenna circuit can be modeled either by a resistor R, a capacitor C and an inductor L coupled in series or in parallel with each other. FIG. 12a has modeled a serial antenna of which a resistor 1203, an inductor 1202 and a capacitor 1201 are coupled in series with each other. FIG. 12b has modeled a parallel antenna of which a resistor 1204, an inductor 1205 and a capacitor 1206 are coupled in parallel with each other. The quality factors of the serial and parallel antennas are respectively shown by equations (30) and (25) indicating that they are the functions of natural frequency and differential resistance properties, and further, the natural frequency is the function of inductance and capacitance which has been shown by equations (31) and (26).

According to equations (3) and (13), the differential of real component, which contributes resistance variations, equals the differential of imaginary component, which contributes capacitance and inductance variations.

As revealed above, capacitance and inductance interact with each other, and, large-scale varying capacitances interact with large-scale varying inductances. Large-scale varying capacitances and inductances of an antenna have more chances to match outside RF excitation frequencies to get into resonant mode resulting in improving quality factor. The PDR and NDR devices as real components and the energy discharge capacitor having broadly varying capacitance as imaginary component decide the inductance of inductor, which will be a lot broader than that of an antenna circuit using pure resistor and capacitor with constant capacitance or only narrowly varying capacitances.

The sensitivity or quality factor Q of the antenna loop of FIGS. 12a and 12b can be improved by replacing the resistor with a serially coupled PDR and NDR devices, and replacing the capacitor with the present invention energy discharge capacitor. FIGS. 12c and 12d have shown the results after those replacements of FIGS. 12a and 12b. A PDR device 1251, a NDR device 1252 and an energy discharge capacitor 1253 have been shown in FIG. 12c and a PDR device 1254, a NDR device 1255 and an energy discharge capacitor 1257 have been shown in FIG. 12d. Ei shown in FIGS. 12a, 12b, 12c and 12d stands for input electromagnetic field.

The present invention is not limited to any particular PDR and NDR devices. For example, the PDR and NDR devices respectively include the positive and negative temperature coefficient resistors respectively in short as PTC and NTC resistors.

1. A capacitor, comprising:
a first conductive electrode;
a second conductive electrode; and
a dielectric disposed between the first conductive electrode and second conductive electrode, wherein
the first conductive electrode is a PDR device and the second electrode is a NDR device.

2. The capacitor of claim 1, wherein the dielectric comprises a first layer, a second layer and a third layer coupled in series of which the second layer is sandwiched between the first and second layers, and the first and third layers are respectively adjacent to the first conductive electrode and the second conductive electrode, and the first and third layers are made of ferroelectric materials and the second layer is made of ferromagnetic or ferro-optical material.

3. The capacitor of claim 1, wherein the dielectric comprises a first layer, a second layer, a third layer and a fourth layer coupled in series of which the second and third layers are disposed between the first and fourth layers, and the first and fourth layers are respectively adjacent to the first conductive electrode and the second conductive electrode, and the first and fourth layers are made of ferroelectric materials and either one of the the second or third layer is made of ferromagnetic material and the other one of the second or third layer is made of ferro-optical material.

4. The capacitor of claim 1, further comprising a first terminal and a second terminal respectively electrically connected with the first conductive electrode and the second electrode for electrically connecting outside circuits, wherein at least two of the first terminal, the second terminal, the first conductive electrode and the second conductive electrode respectively are a PDR device and a NDR device.

5. The capacitor of claim 4, wherein the dielectric comprises a first layer, a second layer and a third layer coupled in series of which the second layer is sandwiched between the first and second layers, and the first and third layers are respectively adjacent to the first conductive electrode and the second conductive electrode, and the first and third layers are made of ferroelectric materials and the second layer is made of ferromagnetic or ferro-optical material.

6. The capacitor of claim 4, wherein the dielectric comprises a first layer, a second layer, a third layer and a fourth layer coupled in series of which the second and third layers are disposed between the first and fourth layers, and the first and fourth layers are respectively adjacent to the first conductive electrode and the second conductive electrode, and the first and fourth layers are made of ferroelectric materials and either one of the the second or third layer is made of ferromagnetic material and the other one of the second or third layer is made of ferro-optical material.

7. The capacitor of claim 1, wherein a closed circuit is formed by electrically connecting the first conductive electrode with a first surface of a conductor where eddy currents are induced and the second conductive electrode electrically connects with a second surface of the conductor without eddy current for dissipating the energy from the eddy currents.

8. The capacitor of claim 4, wherein a closed circuit is formed by electrically connecting the first terminal with a first surface of a conductor where eddy currents are induced and the second terminal electrically connects with a second surface of the conductor without eddy current for dissipating the energy from the eddy currents.

9. The capacitor of claim 7, wherein the closed loop further comprising a NDR device coated on the first surface of the conductor.

10. The capacitor of claim 7, wherein the closed loop further comprising two NDR devices respectively coated on the first and second surfaces of the conductor.

11. The capacitor of claim 8, wherein a layer of the NDR device is coated on the first surface of the conductor.

12. The capacitor of claim 8, wherein a layer of the NDR device is coated on both the first and second surfaces of the conductor.

13. A method for the dissipation of electrical power of a closed circuit by high frequency modulation.

14. The method for the dissipation of electrical power of a closed circuit of claim 13, wherein the closed circuit comprises a PDR device and a NDR device coupled in series and the PDR and NDR devices are interacted with temperature field, magnetic field, optical field, electric field, acoustic field, mechanical field, or any combinations of them.

15. An antenna device, comprising:
a first PDR device;
a first NDR device coupled in series with the first PDR device;
an energy discharge capacitor, comprising:
a first conductive electrode;
a second conductive electrode; and
a dielectric disposed between the first conductive electrode and second conductive electrode, wherein the first conductive electrode is a PDR device and the second electrode is a NDR device; and
an inductor, wherein
the first PDR device, the first NDR device, the energy discharge capacitor and the inductor are coupled in series with each other or the serially coupled first PDR and first NDR devices, the energy discharge capacitor and the inductor are coupled in parallel with each other.

16. The antenna device of claim 15, the energy discharge capacitor further comprising a first terminal and a second terminal respectively electrically connected with the first conductive electrode and the second electrode for electrically connected with outside circuits, wherein at least two of the first terminal, the second terminal, the first conductive electrode and the second conductive electrode respectively are a PDR device and a NDR device.

17. The antenna device of 15, wherein the PDR and NDR devices are interacted with their interacted fields temperature field, magnetic field, optical field, electric field, acoustic field, mechanical field, or any combinations of them.

18. The capacitor of claim 1, wherein the PDR and NDR devices are interacted with temperature field, magnetic field, optical field, electric field, acoustic field, mechanical field, or any combinations of them.

19. The capacitor of claim 4, wherein the PDR and NDR devices are interacted with temperature field, magnetic field, optical field, electric field, acoustic field, mechanical field, or any combinations of them.

20. The capacitor of claim 12, wherein the PDR and NDR devices are interacted with temperature field, magnetic field, optical field, electric field, acoustic field, mechanical field, or any combinations of them.

21. The capacitor of claim 7, wherein the closed circuit further comprising more PDR and NDR devices coupled in series with each other for compensation and the PDR and NDR devices are interacted with temperature field, magnetic field, optical field, electric field, acoustic field, mechanical field, or any combinations of them as perturbing sources in the closed circuit.

22. The capacitor of claim 8, wherein the closed circuit further comprising more PDR and NDR devices coupled in series with each other for compensation and the PDR and NDR devices are interacted with temperature field, magnetic field, optical field, electric field, acoustic field, mechanical field, or any combinations of them as perturbing sources in the closed circuit.

23. The capacitor of claim 9, wherein the closed circuit further comprising more PDR and NDR devices coupled in series with each other for compensation and the PDR and NDR devices are interacted with temperature field, magnetic field, optical field, electric field, acoustic field, mechanical field, or any combinations of them as perturbing sources in the closed circuit.

24. The capacitor of claim 10, wherein the closed circuit further comprising more PDR and NDR devices coupled in series with each other for compensation and the PDR and NDR devices are interacted with temperature field, magnetic field, optical field, electric field, acoustic field, mechanical field, or any combinations of them as perturbing sources in the closed circuit.
